(19) United States
(12) Patent Application Publication
(10) Pub. No.: US 2026/0172973 A1
(43) Pub. Date: Jun. 18, 2026

(54) POWER MANAGEMENT FOR INTERACTIONS WITH TAG BASED SYSTEMS

(71) Applicant: Motorola Mobility LLC, Chicago, IL (US)

(72) Inventors: Vineet Vivekanand Angadi, Dharwad (IN); Vijayakumar GN, Bangalore (IN); Ashwin Kumar M Pathmudi, Pune (IN)

(73) Assignee: Motorola Mobility LLC, Chicago, IL (US)

(21) Appl. No.: 18/978,513

(22) Filed: Dec. 12, 2024

(51) Int. Cl. H04W 52/02; H04W 64/00

(52) U.S. Cl. CPC H04W 52/0254; H04W 64/006

(57) ABSTRACT

An electronic device performs a device operation in an environment that includes a tag based ranging system having at least one tag device. The electronic device interacts with the tag device to perform a ranging function used to derive a device position in the environment. The electronic device communicates with the tag device to update the device position over time. To conserve battery energy of at least one of the electronic device or the tag device, the electronic device automatically adjusts a rate of recurrence of the communications with the tag based ranging system, including to stop or resume the communications, to update the device position in an efficient manner. A decision to stop or resume the communications is based whether the electronic device is stationary state, operating in a particular activity state, or exceeding the limits of a communication range associated with individual tag devices in a cluster.

### BACKGROUND

As technology has advanced electronic devices have become commonplace in our lives. For example, many people have cell phones, smart watches, or other mobile devices with them throughout the day. For a given device state, the electronic devices automatically communicate with other devices in an environment, including Internet of Things (IoT) devices, other mobile devices, vehicles, radio tags, satellites, antenna towers, network equipment, and the like. Frequent communications with these other devices depletes battery power.

### BRIEF DESCRIPTION OF THE DRAWINGS

Embodiments of image-based device customization for multiple users are described with reference to the following drawings. The same numbers are used throughout the drawings to reference like features and components:

FIG. 1 illustrates an example environment for power management for interactions with tag based systems, as described herein.

FIG. 2 illustrates an example tag controller implementing power management for interactions with tag based systems, as described herein.

FIG. 3 illustrates an example tag device implementing power management for interactions with tag based systems, as described herein.

FIG. 4 illustrates an example implementing the techniques discussed herein for managing power based on device interactions with tag based systems, as described herein.

FIG. 5 illustrates an example process for implementing the techniques discussed herein in accordance with one or more embodiments.

FIG. 6 illustrates an example process for implementing the techniques discussed herein in accordance with one or more embodiments.

FIG. 7 illustrates an example process for implementing the techniques discussed herein in accordance with one or more embodiments.

FIG. 8 illustrates various components of an example electronic device that can implement embodiments of the techniques discussed herein.

### DETAILED DESCRIPTION

Power management for interactions with tag based systems is discussed herein. Modern mobile devices (e.g., tablets, phones, watches, glasses) automatically tailor user interfaces and application experiences based on device context, including physical location. Device location is derivable from various sources, with each being implemented on or off the mobile device, including tag-based ranging systems that communicate with a tag controller executing on the mobile device.

Tag-based ranging systems distribute a plurality of ultra-wideband (UWB) radio tag devices in an environment to anchor reference points to different locations. When a mobile device enters the environment, the tag controller communicates UWB radio signals with the tag-based ranging system to obtain ranging information from the reference points. The ranging information (e.g., time of flight measurements, angle of arrival measurements, unique identifiers, measured signal strength) enables the tag controller to derive a precise device location (e.g., within several centimeters). The tag controller interacts with the tag-based ranging system deployed throughout an environment, for instance, to automatically change on-device behavior (e.g., aesthetics of a user interface) or off-device operations, such as for controlling a smart lock, door opener, light, camera, security alarm, or other device. A device operation is modified based on a device location derived from radio communications exchanged with a tag device, which is anchoring a reference point location in the environment.

To facilitate location based user experiences that are responsive and relevant, the device location is updated regularly. Consider a scenario where a user interacts with an electronic device (e.g., a mobile phone) that has a bedtime mode. When operating in the bedtime mode, the electronic device adjusts device operations, such as suppressing notifications, to avoid interfering with a user’s night sleep. The user adjusts tag controller settings to configure the bedtime mode to be triggered automatically whenever the device location is within range (e.g., a few meters) of a radio tag device anchored to a wall of the user’s bedroom. As the user enters the bedroom with the electronic device, communication with the tag device begins to implement ranging functions. The device position is continuously updated through the two-way communication and eventually triggers a seamless transition into the bedtime mode when the device position satisfies a triggering threshold. The device location is continuously updated and monitored during the bedtime mode to enable a responsive transition out of the bedtime mode when the user wakes. When the user exits the bedroom, the device location moves further from the tag device. The communication between the tag controller and the tag device stops, which triggers the seamless transition out of the bedtime mode.

Conventional devices and tag-based ranging systems communicate continuously to implement responsive location based experiences. When conventional communication schemes are used to implement the bedtime mode scenario described above, there is a several hour period of continuous two-way communication exchange from the moment the electronic device enters the bedroom. Maintaining the bedtime mode throughout the user’s night sleep by continuously transmitting radio waves consumes large amounts of electrical power, which drains the battery resources of both devices. By the time the user wakes up, the communications exchanged to support the bedtime mode operations have greatly depleted the battery of the phone and the tag device anchored to the bedroom. Continuous UWB ranging reduces device uptime, which negatively impacts user satisfaction.

Accordingly, power management for interactions with tag based systems is described to reduce electrical power consumption and battery drain when performing radio tag-based device localization. Rather than allow continuous UWB ranging in each scenario, a tag controller is described to efficiently manage each communication session established with a UWB radio tag-based ranging system. The tag controller communicates with a tag device to update a device position over time. To conserve battery energy of at least one of the electronic device or the tag device, the tag controller automatically adjusts a rate of recurrence of the communications with a tag device. This includes changing how often the electronic device and the tag device communicate. Adjusting the rate of recurrence for updating a device position in an efficient manner includes stopping the communications in some situations and resuming the communications in others.

In at least one example, an electronic device executes a tag controller that manages a rate of recurrence of continuous UWB radio communications based on movement and whether the electronic device is stationary state. When the electronic device is moving, a tag controller communicates with a tag based ranging system to update a device position used to modify a device operation over time. When the electronic device is stationary, the device position remains static over time, and the electronic device refrains from updating the device position or at least reduces a rate of recurrence of the communications with the tag based ranging system to conserve electrical energy.

In one or more implementations involving multiple potential communications with multiple tag devices in an environment, an electronic device controls the rate of recurrence of continuous UWB radio communications based on whether the electronic device is executing a particular activity to indicate the information obtained from each of the tags is actively being used. The electronic device detects an activity state of the electronic device that controls a device operation based on a device position obtained from a tag device. The electronic device communicates with the tag device to update the device position and adjusts a rate of the communicating based on whether the electronic device remains in the activity state where the device position is used. When the activity state is changed and the device position is no longer being used, the electronic device refrains updating the device position and stops communicating with the tag device, even if the two devices remain in proximity.

As another example, a tag controller executed by an electronic device implements cluster based communication management techniques to improve efficiency when communicating with a cluster of tag devices arranged in an environment. The tag controller communicates with the cluster to update a device position in the environment for controlling a device operation. The tag controller receives information for communicating with the cluster and describing a plurality of tag devices distributed at different physical locations in an environment. This information can include user defined settings (e.g., from a user inputs) and machine defined radio tag cluster parameters (e.g., from machine-learning based models). The information includes parameters for communicating with each tag device in the cluster including to designate at least one tag device as being a “cluster identifier.” Rather than communicate with each tag device in the cluster, the tag controller conserves device energy by communicating with the cluster identifier and refraining from communicating with each of the other tag devices in the cluster. As the electronic device moves away from the cluster identifier tag device, the distance between the devices exceeds a communication range for the cluster identifier. To maintain communication with the cluster, the tag controller identifies one or more different tag devices from the settings and parameters. The tag controller stops communicating with the cluster identifier and communicates with the different tag device or devices to update the device position in the environment.

Various aspects of implementations described herein can leverage artificial intelligence (AI) functionality (e.g., AI and/or machine learning algorithms, AI and/or machine learning models, etc.) to detect parameters for radio communications with individual or clusters of tag devices arranged in an environment. As discussed herein, the terms “AI” and “machine learning” can be used to refer to machine-implemented intelligence for performing various tasks on data, such as data analysis, data classification, data modification, data generation, etc. For instance, AI functionality can be used for tag device classification, such as to determine whether a tag device is anchored to a nightstand in a bedroom or a refrigerator appliance in a kitchen. Further, AI functionality can be used to determine the device operation to execute in response to radio tag localizing the device position. The described implementations can utilize different types of AI models, such as classifier models, generative models, prediction models, combinations thereof, etc.

Accordingly, the techniques discussed herein improve the operation of a computing device by allowing different electronic devices to be automated in different manners based on power-efficient radio communications with tag based ranging systems.

While features and concepts of power management for interactions with tag based systems can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

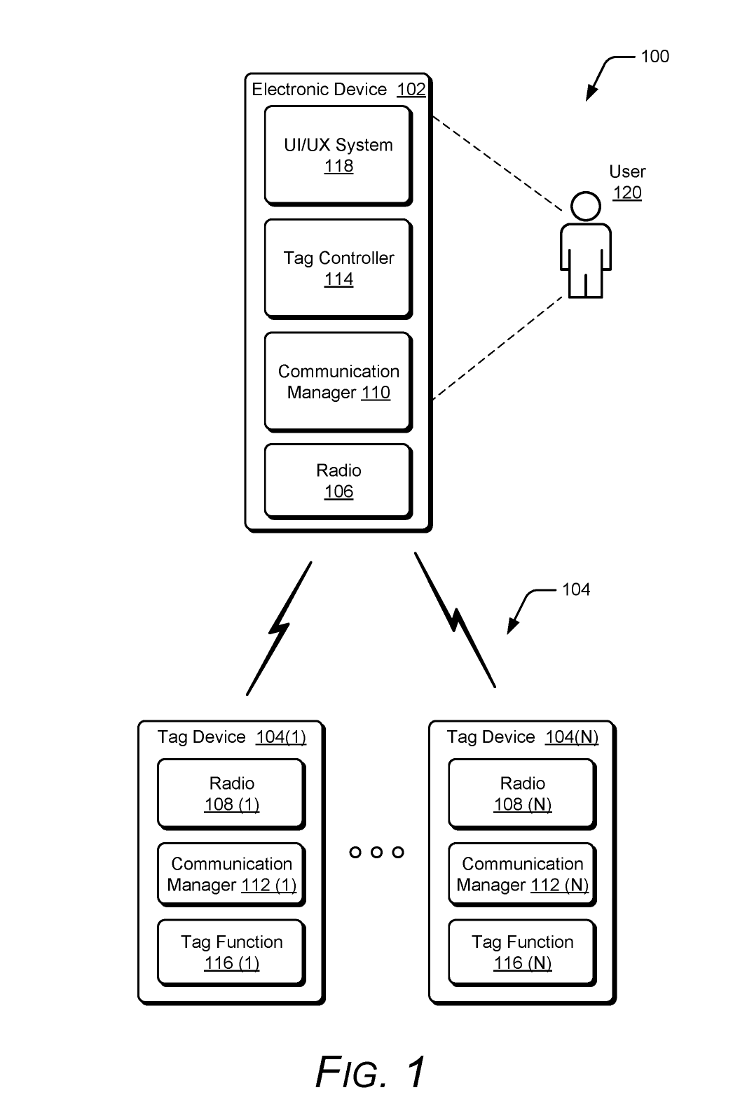

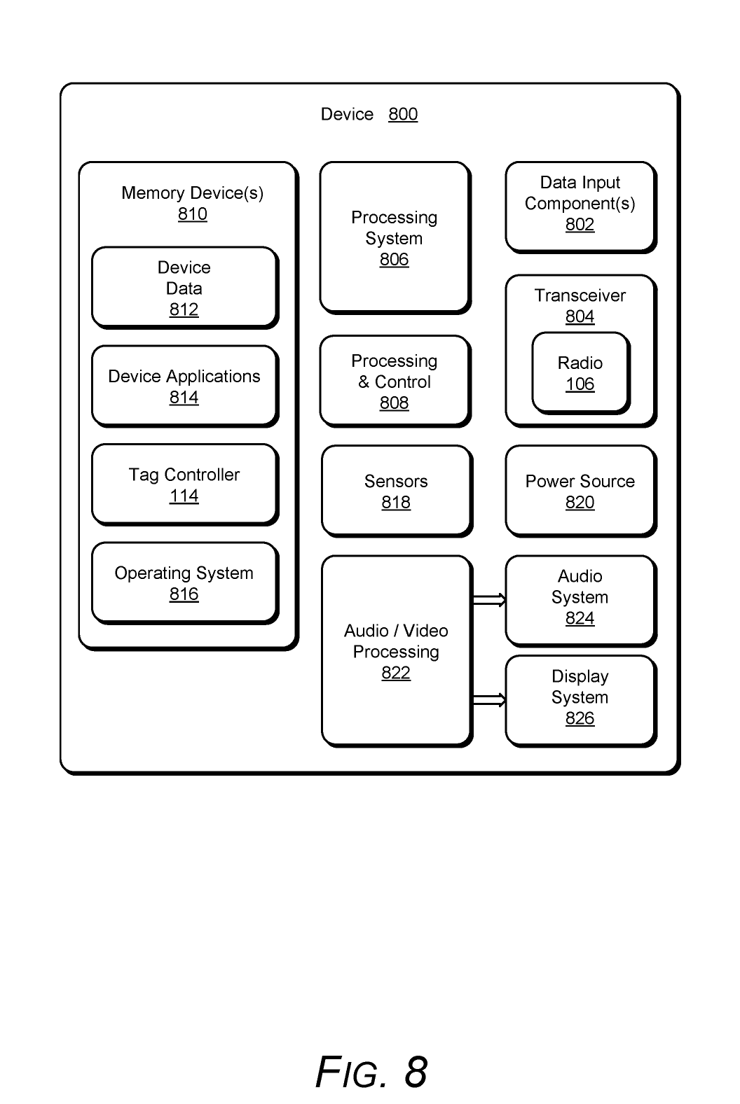

FIG. 1 illustrates an example environment 100 for implementing power management for interactions with tag based systems, as described herein. The example environment 100 includes an electronic device 102 communicatively coupled to one or more tag devices 104(1) through 104(N), where N is a positive, non-zero integer. In one or more implementations, the electronic device 102 can be a smartphone, a mobile phone, a wearable phone (e.g., a smartwatch or a rollable or foldable phone), and/or any other type of wireless device. The electronic device 102 is capable of exchanging communications (e.g., UWB radio signals) with each of the tag devices 104 when the electronic device 102 is brought into the environment 100 (e.g., by a user 120 wearing or in possession of the electronic device 102). In at least one implementation, each of the tag devices 104 represents an individual radio-based tag device of a radio tag based ranging system deployed in the environment 100. The electronic device 102 and the tag devices 104 exchange communications, which include two-way radio signals used to execute ranging and device positioning functions. The electronic devices 102 and the tag devices 104 can be implemented with various components, such as a processor system and memory, as well as any number and combination of different components as further described with reference to the example device shown in FIG. 8.

The electronic device 102 includes a radio 106 for communicating with respective radios 108 of each the tag devices 104, which are labeled as radio 108(1) through radio 108(N). In this illustrated example, each of the radios 106 and 108 represent a hardware component implementing a UWB radio having a UWB transceiver configured to transmit and receive UWB radio signals in the environment 100. In one or more implementations, the radios 106 and 108 include various other types of transceivers for establishing other (non-UWB) wireless communication between devices. For example, the radios 106 and 108 may include a Bluetooth (BT) and/or Bluetooth Low Energy (BLE) transceiver, a beacon transceiver, and/or a near field communication (NFC) transceiver. Additionally or alternatively, the radios 106 and 108 can include a Wi-Fi radio, a global positioning system (GPS) radio, a radio for cellular communication (e.g., a third generation (3G) network, a fourth generation (4G) network, a fifth generation (5G) network, a sixth generation (6G) network), and/or any type of device communication interfaces. The radios 106 and 108 can communicate via one or more intermediary devices (e.g., components of a cellular communication system, a Wi-Fi router) or directly (e.g., wired or wirelessly) without using any intermediary devices (e.g., BT or NFC).

The electronic device 102 includes a communication manager 110 implemented in hardware, software, or combination thereof, for configuring the radio 106 to operate in various radio modes, including a UWB radio mode for transmitting and receiving UWB radio signals with the radios 108. The tag devices 104 include respective communication managers 112, which are labeled as communication manager 112(1) through communication manager 112(N). The communication managers 112 are implemented in hardware, software, or combination thereof, for configuring the radios 108 to operate in various radio modes, including a UWB radio mode for transmitting and receiving UWB radio signals with the radio 106. The communication managers 110 and 112, for instance, implement functions that convert data output in a UWB radio transmission, and decode data input from a UWB radio reception.

The electronic device 102 includes a tag controller 114, which communicates with the tag devices 104 to invoke respective tag functions 116 executed by the tag devices 104 on behalf of the tag controller 114. The tag controller 114 initiates communication with the tag devices 104 and manages ranging parameters received in reply. The tag controller 114, in at least one example, is operable to manage communication and ranging parameters associated with one or more of the tag devices 104, simultaneously.

The tag functions 116 are individually labeled as tag function 116(1) through tag function 116(N). The tag controller 114 interfaces with the communication manager 110 to cause the radio 106 to transmit radio signals to the radios 108. The tag functions 116 interface with the communication managers 112 to compute range parameters associated with the radio transmissions received by the radios 108. The communication managers 112 control the radios 108 to transmit ranging information, including the ranging parameters computed by the tag devices 104 in response to respective communication sessions established by the tag controller 114.

A UI/UX system 118 implements a user interface and/or user experience on the electronic device 102. For a given device state of the electronic device 102, the UI/UX system 118 automatically tailors the user interface and application experiences based on device context, including a physical device location. In at least one example, the UI/UX system 118 uses a device location obtained from the tag controller 114 to modify a device operation over time. The UI/UX system 118 may update the user interface to provide different aesthetics and different capabilities depending on the device location. The UI/UX system 118, in one or more aspects, communicates the device position obtained from the tag controller 114 to an external device communicatively coupled to the electronic device 102. The external device (e.g., that uses the device position to modify an external device operation performed off the electronic device 102 over time.

To facilitate location based user experiences that are responsive and relevant, the UI/UX system 118 requests that the device location be precise and updated regularly. The tag controller 114 communicates with the tag devices 104 to update a device position over time. Continuously exchanging tag based ranging communications depletes battery power. To conserve battery energy of the electronic device 102 and each of the tag devices 104, the tag controller 114 automatically adjusts communications with each of the tag devices 104, including to stop or resume the communications, for updating the device position in an efficient manner. Rather than allow continuous UWB ranging between the tag controller 114 and the tag functions 116, the tag controller 114 efficiently manages each communication session established with the tag devices 104.

In at least one example, the tag controller 114 receives movement information to start and stop the UWB ranging to manage energy consumption. For example, the UI/UX system 118 integrates multiple sensor technology of the electronic device 102 to derive movement state of the electronic device 102. The movement state of the electronic device 102 is used by the UI/UX system 118 to enhance the context behavior of the electronic device 102 as the user 120 wears, holds, or is otherwise in possession of the electronic device 102.

Based on movement data collected for the electronic device 102 (e.g., accelerometer data), the UI/UX system 118 determines whether the electronic device 102 is moving or whether the electronic device 102 is stationary. Updating the device location when the electronic device 102 is stationary wastes processing resources because the device location does not change. The UI/UX system 118 outputs the movement data or other information to the tag controller 114 to indicate whether the electronic device 102 is stationary or is moving.

Based on the movement data received from the UI/UX system 118, the tag controller 114 detects whether the electronic device 102 is in a stationary state. The tag controller 114 adjusts a rate of recurrence of the communications with the tag devices 104 for updating the device position based on whether the electronic device 102 is in the stationary state. For example, the tag controller 114 refrains from invoking the tag functions 116 when the movement data from the UI/UX system 118 indicates that the electronic device 102 is stationary and the device location is not changing. In at least one example, the tag controller 114 stops communicating with the tag devices 104 when the electronic device 102 is in the stationary state. The tag controller 114 continues or resumes communication with the tag device 104 to reinvoke the tag functions 116 when the electronic device 102 exits the stationary state. When the movement data from the UI/UX system 118 indicates that the electronic device 102 is not stationary and the device location is potentially changing, the tag controller 114 updates the device location based on communication reinitiated with the tag devices 104.

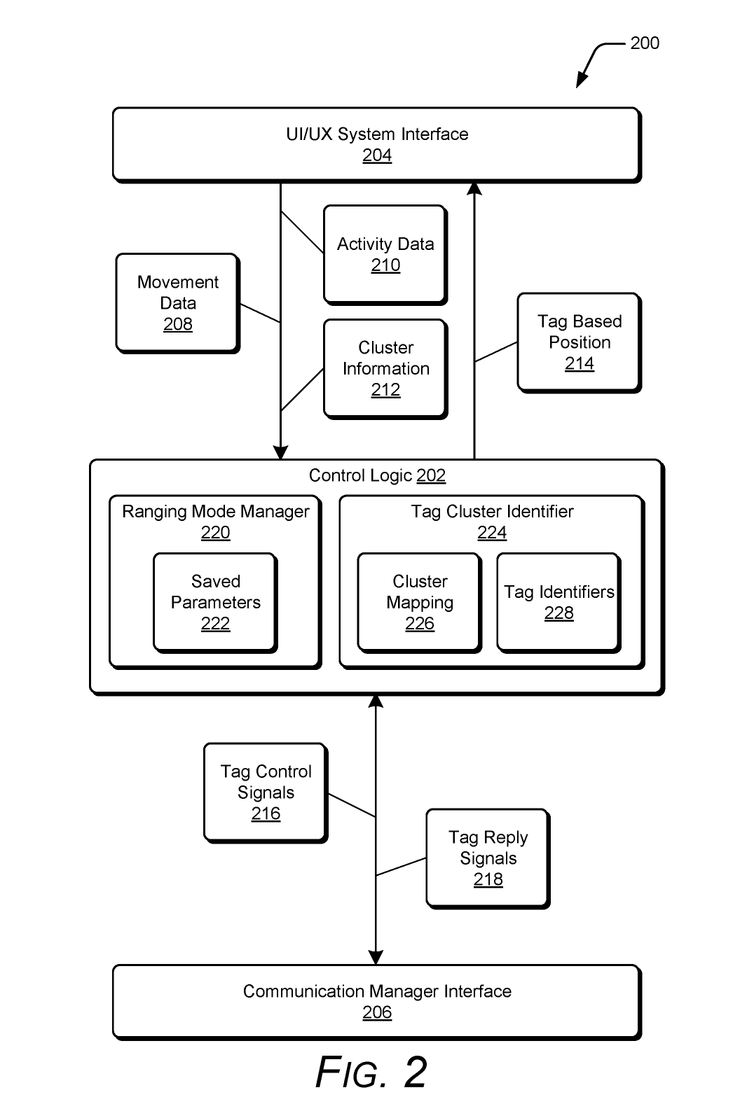

FIG. 2 illustrates an example 200 of the tag controller 114 depicted in FIG. 1, which implements power management for interactions with tag based systems, as described herein. The example 200 may be implemented as a system on chip, as hardware, or as a combination of software or firmware executing on hardware. As illustrated in FIG. 2, the tag controller 114 includes control logic 202 operatively and communicatively coupled to a UI/UX system interface 204 and a communication manager interface 206, for example, implemented as application program interfaces, shared memory addresses, wired or wireless communication channels, or a combination thereof.

The UI/UX system interface 204 collects input and output signals exchanged with the UI/UX system 118. For example, the control logic 202 receives movement data 208, activity data 210, and cluster information 212 from the UI/UX system interface 204, and the control logic 202 outputs a tag based position 214 of the electronic device 102 to the UI/UX system interface 204.

The communication manager interface 206 collects input and output signals exchanged with the communication manager 110 through radio communications exchanged with the tag devices 104. The control logic 202, for instance, outputs tag control signals 216 through the communication manager interface 206 for invoking the tag functions 116. Tag reply signals 218 (e.g., ranging information, tag parameters) based on the tag functions 116 invoked by the tag control signals 216 are input to the control logic 202 through the communication manager interface 206. The control logic 202 uses the tag reply signals 218 to compute the tag based position 214.

The control logic 202 includes a ranging mode manager 220. Implemented in hardware, software, or combination thereof, the ranging mode manager 220 is responsible for configuring the control logic 202 to perform radio tag based ranging in one or more power efficient ways.

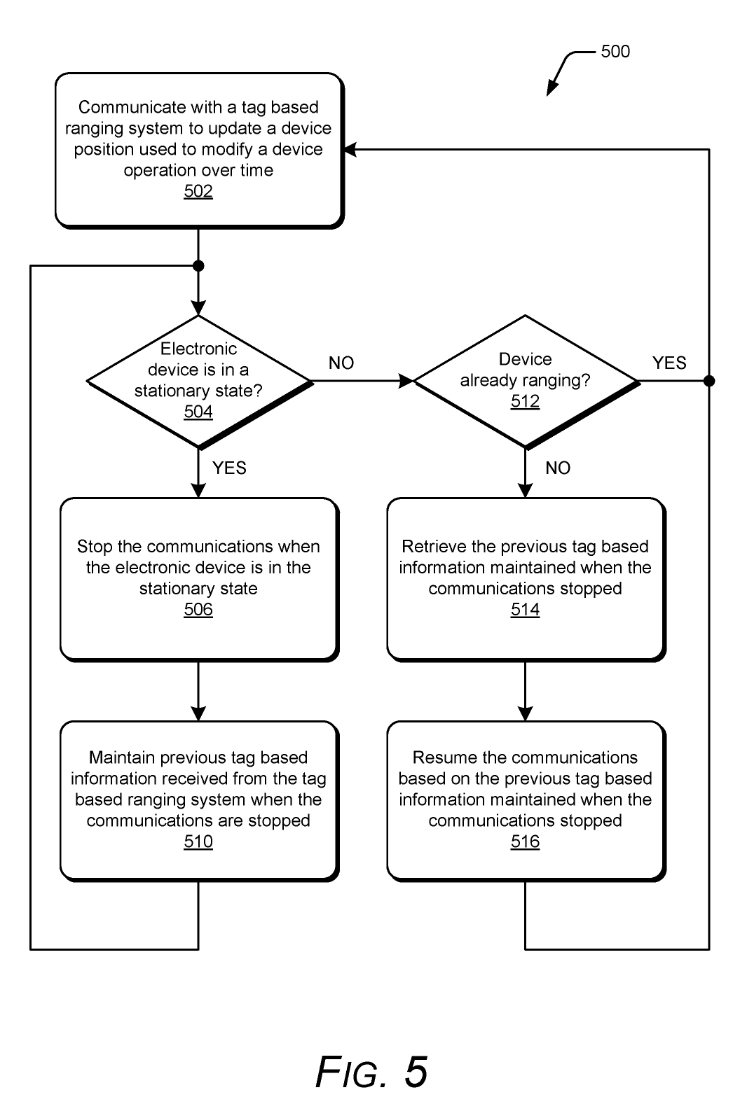

The ranging mode manager 220 implements a movement based radio communication scheme using the movement data 208, which is described in detail with reference to FIG. 5. The movement data 208 indicates whether the electronic device 102 is operating in a stationary state based on sensor measurements indicating movement or lack of movement over time. In at least one example, the movement data 208 represents a communication from the UI/UX system 118 indicating that the electronic device 102 is either stationary or not stationary (and therefore moving). When the electronic device 102 is stationary, the ranging mode manager 220 causes current ranging sessions between the control logic 202 and the tag devices 104 to stop (e.g., to avoid wasting computing resources). When the electronic device 102 moves, the ranging mode manager 220 causes new or the previous ranging sessions between the control logic 202 and the tag devices 104 to start or resume, and update the tag based position 214.

To improve efficiency and speed in starting or resuming the ranging sessions, the ranging mode manager 220 preserves tag parameters and other ranging information as one or more saved parameters 222. Restarting a ranging session based on the saved parameters 222 enables the control logic 202 to seamlessly report updates to the tag based position 214, which enables the UI/UX system 118 or other device operations to respond quickly to as the electronic device 102 exits the stationary state.

In at least one implementation, the saved parameters 222 include various types of information exchanged through the tag control signals 216 and the tag reply signals 218. The saved parameters 222 may include the last tag based position 214 reported to the UI/UX system interface 204. The saved parameters 222 can include time of flight information, which is used by the ranging mode manager 220 to compute the time for the tag control signal 216 and the tag reply signal 218 to travel back and forth between the tag devices 104 and the tag controller 114. A distance between the tag devices 104 and the electronic device 102 is calculable with high precision by the ranging mode manager 220 based on the time of flight information. The saved parameters 222 may include angle of arrival information, which is used by the ranging mode manager 220 to improve accuracy of the time of flight based calculations. The angle of arrival information indicates a direction in the environment 100 from which the radio 106 receives the tag reply signals 218 from the radios 108. Other types of the saved parameters 222 include tag identifier information, a signal strength of the tag reply signals 218, and data payload transmitted on the tag reply signals 218. Each of the tag devices 104 has a unique identifier (e.g., name, number, network address, channel number) that distinguishes that tag device from each other of the tag devices 104. The signal strength is useful to improve quality of the radio communications with the tag devices 104 by providing additional context about the environment 100, such as potential obstacles or interference. The data payload can include tag information to indicate other sensor readings or status information (e.g., battery levels) reported from the tag devices 104. By using the saved parameters 222, the ranging mode manager 220 can quickly resume the tag functions 116 paused when the electronic device 102 became stationary.

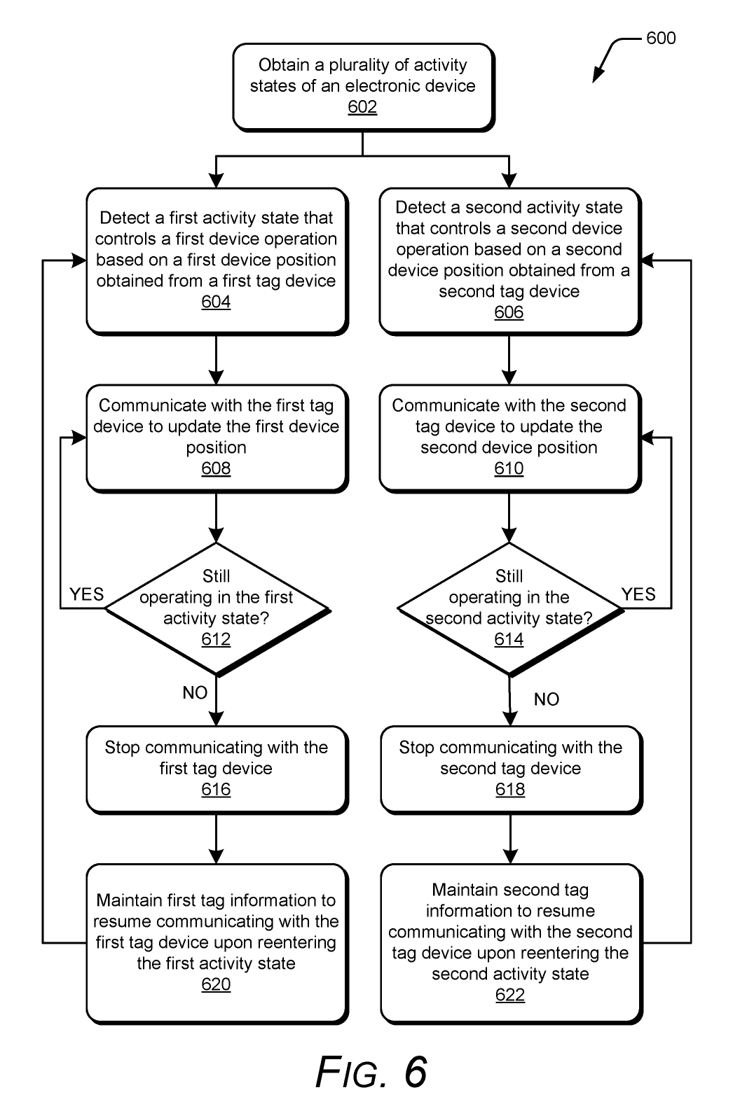

The ranging mode manager 220 implements an activity based radio communication scheme using the activity data 210, which is described in detail with reference to FIG. 6. The activity data 210 indicates an activity state of an application, function, or service executing on the electronic device 102, which relies on the tag functions 116 implemented by the tag devices 104 to perform a device operation. In at least one example, the activity data 210 indicates one or multiple activity states. Each activity state may include an activity identifier to distinguish each application, function, or service utilizing the tag functions 116. For example, the activity identifier specifies an application or thread identifier managed by the UI/UX system 118. With the activity identifier and the activity state, the activity data 210 may include one or more tag device identifiers corresponding to one or more individual tag devices from the tag devices 104. The ranging mode manager 220 identifies one or more of the tag devices 104 assigned to that activity state based on the tag device identifiers. The activity data 210 can also indicate whether the tag based position 214 is presently being in that activity state.

Based on the activity data 210, the ranging mode manager 220 causes current ranging sessions between the control logic 202 and the tag devices 104 to correctly stop, start, or resume (e.g., to avoid wasting computing resources) in coordination with the reported activity state(s). For example, when the activity data 210 describes an activity state of a new thread, which relies on the tag based position 214 obtained from the tag device 104(1), the ranging mode manager 220 establishes radio communication between the radio 106 and the radio 108(1). When the activity data 210 indicates the new thread is not using the tag based position 214 but executing other instruction of the thread, the ranging mode manager 220 pauses the radio communication for that activity state and preserves the saved parameters 222 to enable the communications of that activity state to quickly resume in the future. For example, when the activity data 210 indicates the new thread is using the tag based position 214 again, the ranging mode manager 220 resumes the radio communication for that activity state based on the saved parameters 222.

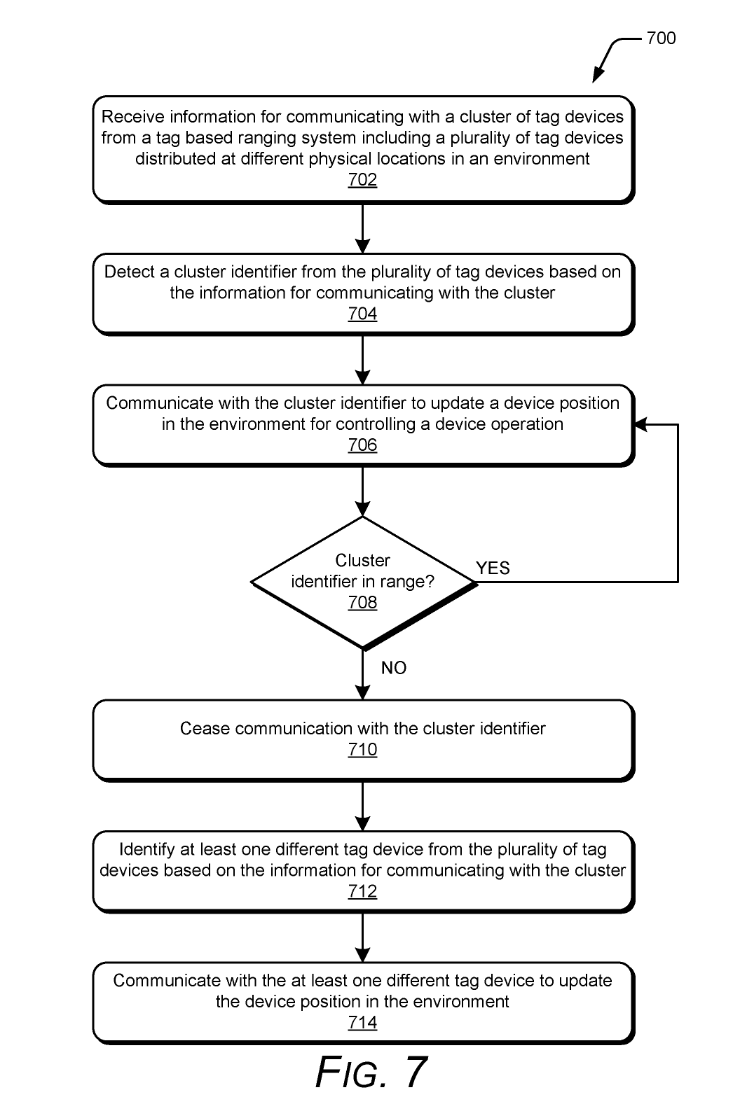

The ranging mode manager 220 implements a cluster based radio communication scheme using the cluster information 212, which is described in detail with reference to FIG. 7. The cluster information 212 represents information describing how to communicate with a cluster of tag devices. The cluster information 212 is received from an external device, an operating system (e.g., part of the UI/UX system 118) executed by the electronic device 102, or a machine-learning model trained to learn the information based on previous communications between the electronic device 102 and the cluster.

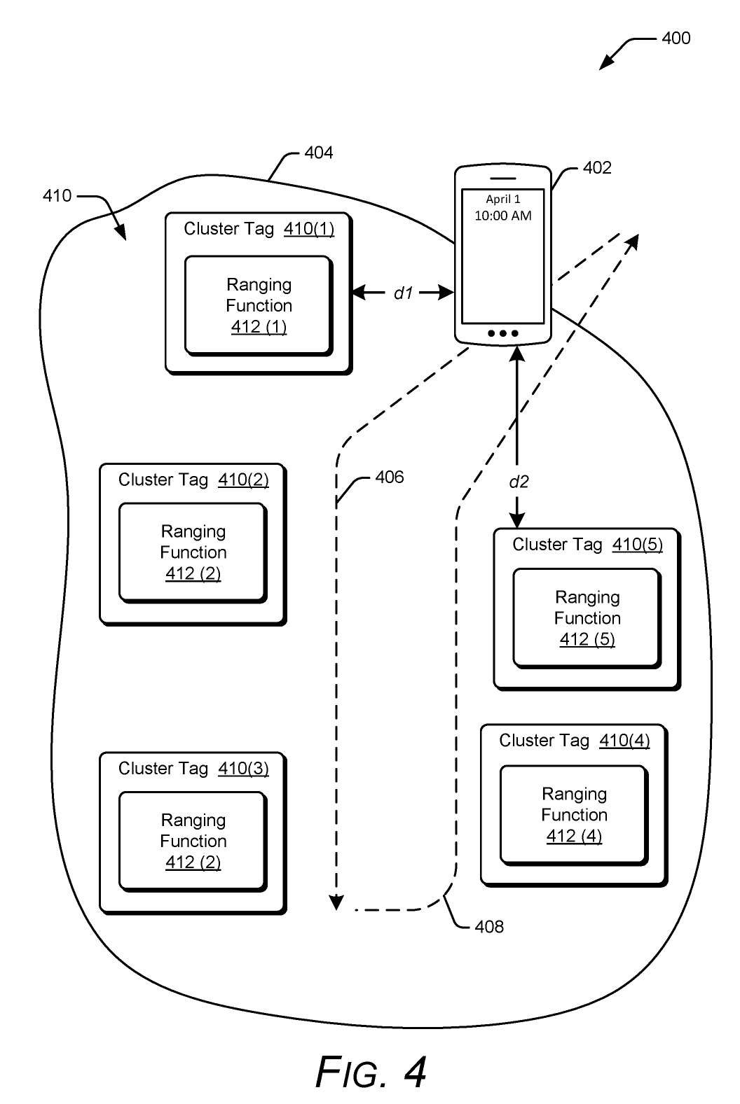

When the cluster information 212 is received by the control logic 202, the ranging mode manager 220 relies on the tag cluster identifier 224 to manage communications between the radio 106 and the tag devices 104 identified to be members of a specific cluster. For example, a large room in a building includes one of the tag devices 104 in a plurality of different corners of the room. Each of the tag devices 104 is operable to implement the tag functions 116 for updating the tag based position 214. The tag cluster identifier 224 receives the cluster information 212 to generate a cluster mapping 226 for a plurality of tag identifiers specified in the cluster information 212 as being part of a particular cluster. The cluster information 212 is generated based on manual input from the user 120, automatically by the UI/UX system 118, or learned by a machine-learned model in communication with the UI/UX system interface 204 to provide the cluster information 212 to the control logic 202. Within the tag identifiers 228 are one or more cluster identifiers. To conserve electrical power, the ranging mode manager 220 may establish communication with the tag devices 104 that are indicated as being the cluster identifiers rather than establishing communication with each of the tag devices 104 in the cluster mapping 226. By monitoring the signal strength and the other saved parameters 222, the ranging mode manager 220 detects when to switch from communicating with the cluster identifiers to communicating with another one of the tag devices 104. For example, based on the recent tag based position 214, the tag cluster identifier 224 outputs a tag identifier 228 associated with one of the tag devices 104 that is closes to the tag based position 214. The ranging mode manager 220 stops communicating with the cluster identifiers and establishes a communication session with the nearest of the tag devices 104 defined by the cluster mapping 226. This situation is described further with reference to the example depicted in FIG. 4.

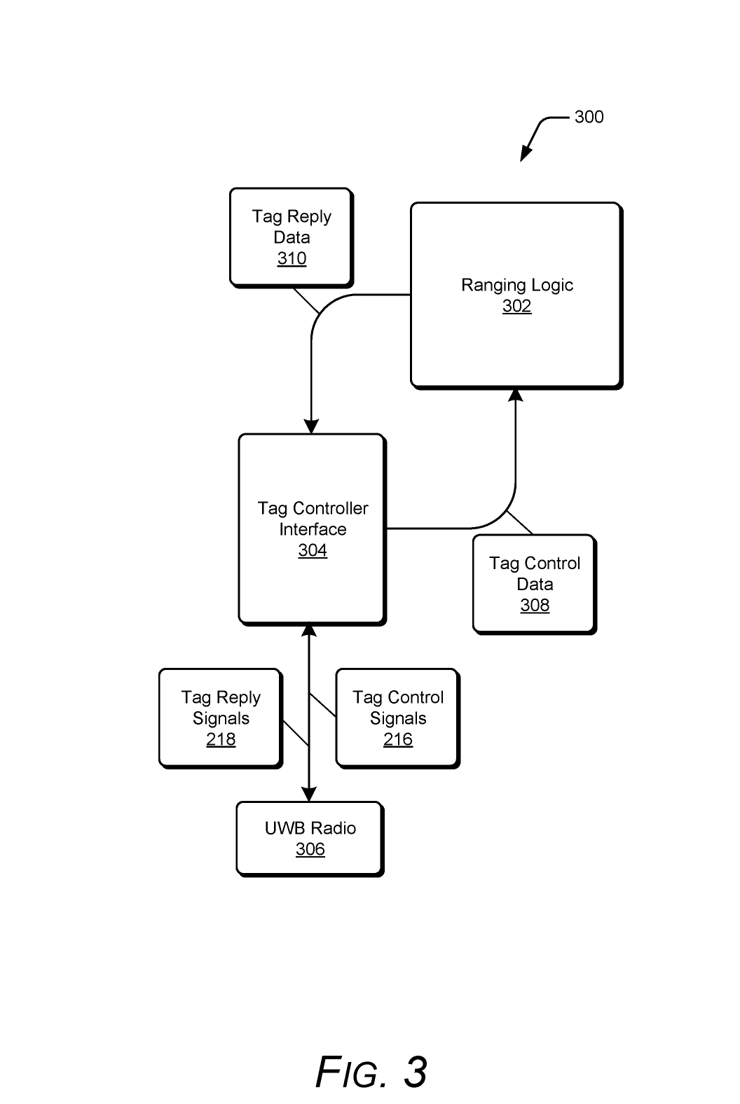

FIG. 3 illustrates an example 300 of each of the tag devices 104 used to implement power management for interactions with tag based systems, as described herein. The example 300 may be implemented as a system on chip, as hardware, or as a combination of software or firmware executing on hardware.

One of the tag devices 104 is illustrated in FIG. 3 as having ranging logic 302 in communication with a tag controller interface 304, which operates a UWB radio 306. The UWB radio 306 is an example of the radio 108, which communicates in a UWB frequency range (e.g., between approximately 3 and 10 GHz). The UWB radio 306 is configured to exchange two-way UWB radio signals with the electronic device 102, including the tag control signals 216 and the tag reply signals 218. The tag controller interface 304 processes the tag control signals 216 into tag control data 308. The tag control data 308 invokes the tag functions 116 implemented by the ranging logic 302. The ranging logic 302 generates tag reply data 310 in response to executing the tag functions 116. The tag controller interface 304 packages the tag reply data 310 into the tag reply signals 218 transmitted by the UWB radio 306.

FIG. 4 illustrates an example 400 implementing the techniques discussed herein for managing power based on device interactions with tag based systems, as described herein. An electronic device 402, which is an example of the electronic device 102, is depicted moving into an environment 404 along a path 406, and then exiting the environment 404 along a path 408. Within the environment 404, a plurality of tag devices 410(1) through 410(5), which are collectively referred to as a cluster 410, are individually anchored to different reference points on either side of the paths 406 and 408. The plurality of tag devices 410(1) through 410(5) are examples of the tag devices 104, including the example 300, which implement a ranging function 412(1) through 412(5), respectively. Although not shown, the electronic device 402 executes the tag controller 114 to communicate with the cluster 410 upon entering the environment 404.

As mentioned above with reference to FIG. 2, the cluster information 212 describes information for communicating with a cluster of tag devices, such as the cluster 410. The tag controller 114 of the electronic device 402 receives the cluster information 212 to enable communications with the cluster 410 when the electronic device 402 into the environment 404. The tag cluster identifier 224 of the control logic 202 of the tag controller 114 receives the cluster information 212 to generate the cluster mapping 226. The cluster mapping 226 indicates a reference location associated with each of the cluster tags 410(1) through 410(5). The cluster information 212 enables the tag cluster identifier 224 to populate the tag identifiers 228 associated with the cluster tags 410(1) through 410(5), including designating at least one indicated by the cluster information 212 as being a cluster identifier.

Rather than immediately establish communication with each of the cluster tags 410(1) through 410(5) upon entering the environment 404, the electronic device 402 conserves electrical power by establishing a single communication link with one of the cluster tags 410(1) through 410(5) that is designated as the cluster identifier and refraining from establishing communication links with each of the other cluster tags 410(1) through 410(5). In at least one example, the cluster identifier is selected based on proximity to an entrance to an environment. For example, the cluster tag 410(1) is set as the cluster identifier for the cluster 410 because a distance d1 between the cluster tag 410(1) and the electronic device 402 is shorter than a distance d2 between the electronic device 402 and the cluster tag 410(5) when the device 402 enters the environment 404 along the path 406. In some examples, when leaving the environment 404 along the path 408, the device 402 sets the cluster tag 410(5) as the cluster identifier for the cluster 410 because the distance d2 is shorter than the distance d1 when the device 402 exists the environment 404 along the path 408.

By monitoring the signal strength and the other saved parameters 222, the ranging mode manager 220 detects when to switch from communicating with the ranging function 412(1) of the cluster tag 410(1) (e.g., the cluster identifier) to communicating with the cluster 410 through a different cluster tag 410(2). In various implementation, the ranging mode manager 220 maintains connections with previous cluster identifiers (e.g., the cluster tag 410(1)) rather than stopping the communication and communicates with one or more additional cluster tags (e.g., the cluster tag 410(2)) to enhance the operations in the environment 404. For example, based on the recent tag based position 214 being nearest to the cluster tag 410(2) as the electronic device 402 moves along the path 406, the electronic device 402 updates the tag based position 214 by invoking the ranging function 412(2). The ranging mode manager 220, optionally stops communicating with the cluster tag 410(1) and, based in part on the saved parameters 222, establishes a communication session with the cluster tag 410(2), which is the nearest of the tag devices 104 defined by the cluster mapping 226. This processes repeats as the electronic device 402 moves beyond the communication range of one tag device from the cluster 410 and into the communication range of another tag device from the cluster 410. For example, as the electronic device 402 moves along the path 408 to exit the environment, the electronic device 402 sequentially establishes an individual communication session with each of the cluster tags 410(3) through 410(5) including to stop individual communication sessions in various aspects.

FIG. 5 illustrates an example process 500 for implementing the techniques discussed herein in accordance with one or more embodiments. The process 500 is carried out at least in part by a tag controller for a radio tag based ranging system that includes one or more tag devices, such as the tag controller 114, and can be implemented in software, firmware, hardware, or combinations thereof. The process 500 is shown as a set of acts and is not limited to the order shown for performing the operations of the various acts.

In the process 500, communication with a tag based ranging system occurs to update a device position used to modify a device operation over time (act 502). For example, the tag controller 114 implements a movement based communication scheme to derive the tag based position 214 by invoking one or more of the ranging functions 116 implemented by the tag devices 104.

Next, the process 500 includes detecting whether an electronic device is in a stationary state (act 504). The movement data 208 is received from the UI/UX system 118, for example. Whether the electronic device 102 is in a stationary state or not in a stationary state is determined by the tag controller 114.

In response to detecting the electronic device in the stationary state (act 504, YES), the process 500 includes stopping the communications when the electronic device is in the stationary state (act 506). For example, the tag controller 114 saves electrical energy by not communicating with the tag devices 104 when the tag based position 214 is not changing.

The process 500 continues with maintaining previous tag based information received from the tag based ranging system when the communications are stopped (act 510). For example, the saved parameters 222 provide an entry point to efficiently resume the radio tag based ranging when the electronic device 102 moves.

In response to detecting the electronic device not being in the stationary state (act 504, NO), the process 500 includes by checking whether the device is already ranging (act 512). For example, the tag controller 114 saves electrical energy by stopping communications with the tag devices 104 when the tag based position 214 is not changing. The tag controller 114 is also careful not to interfere with existing ranging processes. In response to detecting that the device is already ranging (act 512, YES), the process 500 continues by returning to act 502. Conversely, in response to detecting that the device is not already ranging (act 512, NO), the process 500 continues by retrieving the previous tag based information maintained when the communications stopped (act 514). The saved parameters 222, for instance, are retrieved by the tag controller 114 to define a starting point for resuming the tag based position 214 updates after the communications were stopped at the act 506.

The process 500 concludes with resuming the communications based on the previous tag based information maintained when the communication stopped (act 516). The saved parameters 222, for instance, enable the tag controller 114 to carry-on with updating the tag based position 214 from where the tag functions 116 left off when the communications were stopped at the act 506.

FIG. 6 illustrates an example process 600 for implementing the techniques discussed herein in accordance with one or more embodiments. The process 600 is carried out at least in part by a tag controller for a radio tag based ranging system that includes one or more tag devices, such as the tag controller 114, and can be implemented in software, firmware, hardware, or combinations thereof. The process 600 is shown as a set of acts and is not limited to the order shown for performing the operations of the various acts. In the process 600, communication with a tag based ranging system occurs adheres to an activity based communication scheme for updating a device position .

The process 600 begins with obtaining a plurality of activity states of an electronic device (act 602). The tag controller 114, for instance, receives the activity data 210 from the UI/UX system 118 and determined multiple activity states associated with the electronic device 102 that potentially rely on the tag based position 214.

The process 600 continues by detecting a first activity state that controls a first device operation based on a first device position obtained from a first tag device (act 604) and detecting a second activity state that controls a second device operation based on a second device position obtained from a second tag device (act 606). For example, the activity data 210 indicates the tag device 104(1) is to provide a first indication of the tag based position 214, and that the tag device 104(N) is to provide a second indication of the tag based position 214.

Next, the process 600 includes communicating with the first tag device to update the first indication of the device position (act 608) and communicating with the second tag device to update the second indication of the device position (act 61). For example, the tag controller 114 is communicating with the tag device 104(1) to derive a first indication of the tag based position 214, and the tag controller 114 is communicating with the tag device 104(N) to derive a second indication of the tag based position 214.

In continuing the process 600, whether the first activity state is still operating is determined (act 612) and whether the second activity state is still operating is determined (act 614). For example, if the activity data 210 indicates to the ranging mode manager 220 that the first indication of the tag based position 214 is being used by the first activity, then the process 600 returns to act 608 from the YES branch of the act 612. Likewise, if the activity data 210 indicates to the ranging mode manager 220 that the second indication of the tag based position 214 is being used by the second activity, then the process 600 returns to the act 610 from YES branch out of the act 614.

In contrast, if the activity data 210 indicates to the ranging mode manager 220 that the first indication of the tag based position 214 is not being used by the first activity, then the process 600 continue to act 616 from the NO branch of the act 612. Likewise, if the activity data 210 indicates to the ranging mode manager 220 that the second indication of the tag based position 214 is not being used by the second activity, then the process 600 continues to the act 618 from NO branch out of the act 614.

The process 600 next includes adjusting a rate of the communicating with the tag devices 104(1) and 104(N) based on whether the electronic device 102 remains in either of the first or second activity states. The rate of the communicating is maintained when the tag based position 214 is being used. The rate of communicating is reduced to zero (e.g., stopped) when the tag based position 214 is not being used. When the first indication of the tag based position 214 is not being used by the first activity state, the process 600 includes stopping communicating with the first tag device (act 616). For example, the tag controller 114 pauses the communications with the radio 108(1). Likewise, When the second indication of the tag based position 214 is not being used by the second activity state, the process 600 includes stopping communicating with the second tag device (act 616). The tag controller 114, for instance, stops the communications with the radio 108(N).

To quickly and efficiently resume the tag functions 116 by communicating with either of the tag devices 104(1) and 104(N), the tag controller 114 preserves tag information, such as the saved parameters 222. The process 600 includes maintaining first tag information to resume communicating with the first tag device upon reentering the first activity state (act 620) and maintaining second tag information to resume communicating with the second tag device upon reentering the second activity state (act 622). For example, the saved parameters 222 include ranging information and tag parameters associated with the tag device 104(1) separate from the saved parameters 222, which include similar information associated with the tag device 104(N).

FIG. 7 illustrates an example process 700 for implementing the techniques discussed herein in accordance with one or more embodiments. The process 700 is carried out at least in part by a tag controller for a radio tag based ranging system that includes a cluster of multiple tag devices, such as the tag controller 114 in communication with the cluster 410, and can be implemented in software, firmware, hardware, or combinations thereof. The process 700 is shown as a set of acts and is not limited to the order shown for performing the operations of the various acts. In the process 700, communication with a tag based ranging system adheres to a tag cluster based communication scheme for updating a device position.

The process 700 begins with receiving information for communicating with a cluster of tag devices from a tag based ranging system including a plurality of tag devices distributed at different physical locations in an environment (act 702). For example, the tag controller 114 obtains the cluster information 212 from the UI/UX system 118, which includes receiving the cluster information 212 from an operating system of the electronic device 102, a machine-learning model accessed by the electronic device 102, or communicated to the electronic device 102 from an external device (e.g., via a connection to a network or the cloud).

The process 700 continues by detecting a cluster identifier from the plurality of tag devices based on the information for communicating with the cluster (act 704). The control logic 202, for instance, receives the cluster information 212 and the tag cluster identifier 224 uses the cluster information 212 to build the cluster mapping 226 and detect the tag identifiers 228, including at least one of the cluster tags 410(1) through 410(5) as the cluster identifier to use for communicating with the cluster 410. In this example, the tag identifiers 228 indicate that the cluster tag 410(1) is the cluster identifier of the cluster 410.

The process 700 next includes communicating with the cluster identifier to update a device position in the environment for controlling a device operation (act 706). The control logic 202 exchanges the tag control signals 216 and the tag reply signals 218 with the cluster tag 410(1), for example, to implement the ranging function 412(1). The device position of the device 402 determined by the ranging function 412(1) is used to modify behavior or aesthetics of the device 402, for instance, to implement an augmented reality experience output by the UI/UX system 118, which changes as the device 402 moves within the environment 404.

The process 700 continues with determining whether the cluster identifier is in range (act 708). The device 402 communicates with a single cluster identifier to conserve electrical and computing resources of the device 402 and the cluster 410, overall, by communicating with a single cluster identifier. Communicating with the cluster tag 410(1) to implement the ranging function 412(1) without communicating with each of the other cluster tags 410(2) through 410(5) reduces battery drain localizing the device 402 within the environment 404. The process follows the YES path from the act 708 and the device 402 continues to communicate with the cluster 410 through the cluster tag 410(1). If at some point after communicating with the lone cluster identifier, the distance d1 between the device 402 and the cluster tag 410(1) increases beyond a distance threshold, then the device 402 may no longer be within a communication range of the cluster tag 410(1). For example, an obstruction in the environment 404 reduces signal strength of the signals exchanges between the device 402 and the cluster tag 410(1). The process follows the NO path from the act 708 for initiating communication with a different one or more of the cluster tags 410(2) through 410(5) to implement the ranging functions 412 and determine the device position within the environment 404.

After determining that the cluster identifier exceeds the communication range, the process 700 includes ceasing communication with the cluster identifier (act 710). The device 402 stops communicating with the cluster tag 410(1).

Next, the process 700 includes identifying at least one different tag device from the plurality of tag devices based on the information for communicating with the cluster (act 712). For example, the control logic 202 uses the tag cluster identifier 224 to determine from the cluster mapping 226 another nearby cluster tag from the cluster 410 to use as the cluster identifier instead of the cluster tag 410(1). The device moves along the path 406 and the next cluster identifier used includes one or more of the tag cluster 410(2) and the cluster 410(5), for instance.

Then, with a different cluster identifier or multiple tag devices from the cluster 410, the process 700 includes communicating with the at least one different tag device to update the device position in the environment (act 714). The device 402 initiates communication with a different one or more of the cluster tags 410(2) through 410(5) to implement the ranging functions 412 and determine the device position within the environment 404.

FIG. 8 illustrates various components of an example electronic device that can implement embodiments of the techniques discussed herein. The electronic device 800 can be implemented as any of the devices described with reference to the previous FIG.s, such as any type of client device, mobile phone, tablet, computing, communication, entertainment, gaming, media playback, or other type of electronic device. In one or more embodiments the electronic device 800 includes the tag controller 114, described above.

The electronic device 800 includes one or more data input components 802 via which any type of data, media content, or inputs can be received such as user-selectable inputs, messages, music, television content, recorded video content, and any other type of text, audio, video, or image data received from any content or data source. The data input components 802 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 802 may also include various other input components such as microphones, touch sensors, touchscreens, keyboards, and so forth.

The device 800 includes communication transceivers 804 that enable one or both of wired and wireless communication of device data with other devices. The device data can include any type of text, audio, video, image data, or combinations thereof. The radio 106 is an example of the transceivers 804, which is configured to transmit and receive UWB radio signals. Further examples of the transceivers 804 include wireless personal area network (WPAN) radios compliant with various IEEE 802.15 (Bluetooth^{TM}) standards, wireless local area network (WLAN) radios compliant with any of the various IEEE 802.11 (WiFi^{TM}) standards, wireless wide area network (WWAN) radios for cellular phone communication, wireless metropolitan area network (WMAN) radios compliant with various IEEE 802.15 (WiMAX^{TM}) standards, wired local area network (LAN) Ethernet transceivers for network data communication, and cellular networks (e.g., third generation networks, fourth generation networks such as LTE networks, or fifth generation networks).

The device 800 includes a processing system 806 of one or more processors (e.g., any of microprocessors, controllers, and the like) or a processor and memory system implemented as a system-on-chip (SoC) that processes computer-executable instructions. The processing system 806 may be implemented at least partially in hardware, which can include components of an integrated circuit or on-chip system, an application-specific integrated circuit (ASIC), a field-programmable gate array (FPGA), a complex programmable logic device (CPLD), and other implementations in silicon or other hardware.

Alternately or in addition, the device can be implemented with any one or combination of software, hardware, firmware, or fixed logic circuitry that is implemented in connection with processing and control circuits, which are generally identified at 808. The device 800 may further include any type of a system bus or other data and command transfer system that couples the various components within the device. A system bus can include any one or combination of different bus structures and architectures, as well as control and data lines.

The device 800 also includes computer-readable storage memory devices 810 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 810 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory device 810 provides data storage mechanisms to store the device data 812, other types of information or data, and various device applications 814 (e.g., software applications). For example, an operating system 816 can be maintained as software instructions with a memory device and executed by the processing system 806 to cause the processing system 806 to perform various acts. The memory device 810 may also include a device manager, such as the tag controller 114, and any other form of a control application, software application, signal-processing and control module, code that is native to a particular device, a hardware abstraction layer for a particular device, and so on. The tag controller 114 is implemented as part of the operating system 816 in at least one implementation and implemented as one of the device applications 814 in at least one other example.

The device 800 can also include one or more device sensors 818, such as any one or more of an ambient light sensor, a proximity sensor, a touch sensor, an infrared (IR) sensor, accelerometer, gyroscope, thermal sensor, audio sensor (e.g., microphone), and the like. The device 800 can also include one or more power sources 820, such as when the device 800 is implemented as a mobile device. The power sources 820 may include a charging or power system, and can be implemented as a flexible strip battery, a rechargeable battery, a charged super-capacitor, or any other type of active or passive power source.

The device 800 additionally includes an audio or video processing system 822 that generates one or both of audio data for an audio system 824 and display data for a display system 826. In accordance with some embodiments, the audio/video processing system 822 is configured to receive call audio data from the transceiver 804 and communicate the call audio data to the audio system 824 for playback at the device 800. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Alternatively, the audio system or the display system are external, peripheral components to the example device.

Although embodiments of techniques for power management for interactions with tag based systemshave been described in language specific to features or methods, the subject of the appended claims is not necessarily limited to the specific features or methods described. Rather, the specific features and methods are disclosed as example implementations of techniques for power management for interactions with tag based systems. Further, various different embodiments are described, and it is to be appreciated that each described embodiment can be implemented independently or in connection with one or more other described embodiments. Additional aspects of the techniques, features, and/or methods discussed herein relate to one or more of the following aspects.

In some aspects, the techniques described herein relate to an electronic device, including: at least one memory, and at least one processor coupled with the at least one memory and configured to cause the electronic device to: communicate with a tag based ranging system to update a device position used to modify a device operation over time, detect whether the electronic device is in a stationary state, and adjust a rate of recurrence of communications with the tag based ranging system to update the device position including to stop or resume the communications based on whether the electronic device is in the stationary state.

In some aspects, the techniques described herein relate to an electronic device, wherein the tag based ranging system includes at least one ultra-wideband radio-based tag device, and the communications include two-way ultra-wideband radio signals transmitted between the electronic device and the at least one ultra-wideband radio-based tag device.

In some aspects, the techniques described herein relate to an electronic device, wherein the at least one processor is configured to cause the electronic device to detect whether the electronic device is in the stationary state based on movement data collected for the electronic device.

In some aspects, the techniques described herein relate to an electronic device, wherein the at least one processor is configured to cause the electronic device to adjust the rate of recurrence by decreasing the rate of recurrence to stop the communications when the electronic device is in the stationary state.

In some aspects, the techniques described herein relate to an electronic device, wherein the at least one processor is configured to cause the electronic device to maintain previous tag based information received from the tag based ranging system when the communications are stopped, and use the previous tag based information to resume the communications.

In some aspects, the techniques described herein relate to an electronic device, wherein the tag based ranging system includes a cluster of tag devices including a plurality of radio tag devices distributed in an environment.

In some aspects, the techniques described herein relate to an electronic device, wherein the at least one processor is configured to cause the electronic device to adjust the rate of recurrence by increasing the rate of recurrence to resume the communications when the electronic device is not in the stationary state.

In some aspects, the techniques described herein relate to an electronic device, wherein the at least one processor is configured to cause the electronic device to refrain from adjusting the rate of recurrence when the device position is used to modify the device operation when the electronic device is in the stationary state.

In some aspects, the techniques described herein relate to an electronic device, wherein the at least one processor is configured to cause the electronic device to modify the device operation over time by updating a user interface of the device based on the device position.

In some aspects, the techniques described herein relate to an electronic device, wherein the at least one processor is configured to cause the electronic device to communicate the device position to an external device that uses the device position to modify an external device operation over time.

In some aspects, the techniques described herein relate to a method, including: detecting, by an electronic device, an activity state of the electronic device that controls a device operation based on a device position obtained from a tag device, communicating, by the electronic device, with the tag device to update the device position, and adjusting, by the electronic device, a rate of the communicating based on whether the electronic device remains in the activity state including to stop or resume the communicating.

In some aspects, the techniques described herein relate to a method, further including: identifying the tag device from a plurality of tag devices included in a cluster of tag devices assigned to the activity state.

In some aspects, the techniques described herein relate to a method, the adjusting further including: maintaining the rate of the communicating when the electronic device remains in the activity state, and stopping the communicating when the electronic device exits in the activity state.

In some aspects, the techniques described herein relate to a method, further including: maintaining previous tag information generated prior to the stopping, and after the stopping, using the previous tag information to resume the communicating to update the device position.

In some aspects, the techniques described herein relate to a method, wherein the activity state represents a first activity state that controls a first device operation based on a device position obtained from a first tag device, the method further including: detecting a second activity state of the electronic device that controls a second device operation based on a second device position obtained from a second tag device, and communicating, by the electronic device, with the second tag device independent from the communicating with the first tag device to update the second device position when the electronic device remains in the second activity state.

In some aspects, the techniques described herein relate to a system, including: at least one memory, and at least one processor coupled with the at least one memory and configured to cause the system to: receive information for communicating with a cluster of tag devices from a tag based ranging system including a plurality of tag devices distributed at different physical locations in an environment, detect a cluster identifier from the plurality of tag devices based on the information for communicating with the cluster, communicate with the cluster identifier to update a device position in the environment for controlling a device operation, cease communication with the cluster identifier and identify at least one different tag device from the plurality of tag devices based on the information for communicating with the cluster when the cluster identifier exceeds a communication range, and communicate with the at least one different tag device to update the device position in the environment.

In some aspects, the techniques described herein relate to a system, wherein the information for communicating with the cluster describes parameters of each tag device in the cluster.

In some aspects, the techniques described herein relate to a system, wherein a first parameter of one or more first tag devices in the cluster designate each of the one or more first tag devices as being the cluster identifier.

In some aspects, the techniques described herein relate to a system, wherein the at least one different tag device includes each tag device in the cluster other than the cluster identifier.

In some aspects, the techniques described herein relate to a system, wherein the information for communicating with the cluster is received from an external device, an operating system executed by the at least one processor, or a machine-learning model trained to learn the information based on previous communications with the cluster.

What is claimed is:

1. An electronic device, comprising:
at least one memory; and
at least one processor coupled with the at least one memory and configured to cause the electronic device to:
communicate with a tag based ranging system to update a device position used to modify a device operation over time;
detect whether the electronic device is in a stationary state; and
adjust a rate of recurrence of communications with the tag based ranging system to update the device position including to stop or resume the communications based on whether the electronic device is in the stationary state.

2. The electronic device of claim 1, wherein the tag based ranging system comprises at least one ultra-wideband radio-based tag device, and the communications include two-way ultra-wideband radio signals transmitted between the electronic device and the at least one ultra-wideband radio-based tag device.

3. The electronic device of claim 1, wherein the at least one processor is configured to cause the electronic device to detect whether the electronic device is in the stationary state based on movement data collected for the electronic device.

4. The electronic device of claim 1, wherein the at least one processor is configured to cause the electronic device to adjust the rate of recurrence by decreasing the rate of recurrence to stop the communications when the electronic device is in the stationary state.

5. The electronic device of claim 4, wherein the at least one processor is configured to cause the electronic device to maintain previous tag based information received from the tag based ranging system when the communications are stopped, and use the previous tag based information to resume the communications.

6. The electronic device of claim 1, wherein the tag based ranging system comprises a cluster of tag devices including a plurality of radio tag devices distributed in an environment.

7. The electronic device of claim 1, wherein the at least one processor is configured to cause the electronic device to adjust the rate of recurrence by increasing the rate of recurrence to resume the communications when the electronic device is not in the stationary state.

8. The electronic device of claim 1, wherein the at least one processor is configured to cause the electronic device to refrain from adjusting the rate of recurrence when the device position is used to modify the device operation when the electronic device is in the stationary state.

9. The electronic device of claim 1, wherein the at least one processor is configured to cause the electronic device to modify the device operation over time by updating a user interface of the device based on the device position.

10. The electronic device of claim 1, wherein the at least one processor is configured to cause the electronic device to communicate the device position to an external device that uses the device position to modify an external device operation over time.

11. A method, comprising:
detecting, by an electronic device, an activity state of the electronic device that controls a device operation based on a device position obtained from a tag device;
communicating, by the electronic device, with the tag device to update the device position; and
adjusting, by the electronic device, a rate of the communicating based on whether the electronic device remains in the activity state including to stop or resume the communicating.

12. The method of claim 11, further comprising:
identifying the tag device from a plurality of tag devices included in a cluster of tag devices assigned to the activity state.

13. The method of claim 11, the adjusting further comprising:
maintaining the rate of the communicating when the electronic device remains in the activity state; and
stopping the communicating when the electronic device exits in the activity state.

14. The method of claim 13, further comprising:
maintaining previous tag information generated prior to the stopping; and
after the stopping, using the previous tag information to resume the communicating to update the device position.

15. The method of claim 11, wherein the activity state represents a first activity state that controls a first device operation based on a device position obtained from a first tag device, the method further comprising:
detecting a second activity state of the electronic device that controls a second device operation based on a second device position obtained from a second tag device; and
communicating, by the electronic device, with the second tag device independent from the communicating with the first tag device to update the second device position when the electronic device remains in the second activity state.

16. A system, comprising:
at least one memory; and
at least one processor coupled with the at least one memory and configured to cause the system to:
receive information for communicating with a cluster of tag devices from a tag based ranging system including a plurality of tag devices distributed at different physical locations in an environment;
detect a cluster identifier from the plurality of tag devices based on the information for communicating with the cluster;
communicate with the cluster identifier to update a device position in the environment for controlling a device operation;
cease communication with the cluster identifier and identify at least one different tag device from the plurality of tag devices based on the information for communicating with the cluster when the cluster identifier exceeds a communication range; and
communicate with the at least one different tag device to update the device position in the environment.

17. The system of claim 16, wherein the information for communicating with the cluster describes parameters of each tag device in the cluster.

18. The system of claim 17, wherein a first parameter of one or more first tag devices in the cluster designate each of the one or more first tag devices as being the cluster identifier.

19. The system of claim 16, wherein the at least one different tag device includes each tag device in the cluster other than the cluster identifier.

20. The system of claim 16, wherein the information for communicating with the cluster is received from an external device, an operating system executed by the at least one processor, or a machine-learning model trained to learn the information based on previous communications with the cluster.
